(19) United States
(12) Patent Application Publication
(10) Pub. No.: US 2008/0186249 A1
(43) Pub. Date: Aug. 7, 2008

(54) USING A PROTECTIVE HOUSING AND A PRESSURIZED MECHANISM TO PROTECT BASE STATION ANTENNAS

(75) Inventors: ROCCO OTTOLINO, CHICAGO, IL (US); JAMES P. MORAN, VILLA PARK, IL (US)

Correspondence Address: PATENTS ON DEMAND, P.A., 4581 WESTON ROAD, SUITE 345, WESTON, FL, 33331, US

(73) Assignee: MOTOROLA, INC., SCHAUMBURG, IL (US)

(21) Appl. No.: 11/554,678

(22) Filed: Oct. 31, 2006

(51) Int. Cl. H01Q 1/42

(52) U.S. Cl. 343/872

(57) ABSTRACT

The present invention discloses a system for protecting a base station antenna that includes an antenna mounted to a platform base. The platform base can be raised and lowered depending upon an amount of pressure in a pressure chamber. A pressure generator can increase the amount of pressure in the pressure chamber. A depressurization valve can decrease the amount of pressure in the pressure chamber. A protective housing can protect the antenna from environmental conditions. When in a deactivated state, the antenna can be lowered into the protective housing. When in an operational state, at least a portion of the antenna can be raised above the protective housing so that the antenna can send and receive radio frequency signals.

### BACKGROUND

1. The present invention relates to telecommunications and, more particularly, to utilizing a protective housing and a pressurized mechanism to protect base station antennas.

2. Description of the Related Art

Wireless telecommunication providers face numerous challenges from weather-related events and natural disasters, such as tornados, hurricanes, severe storms, floods and earthquakes. On one hand, it is desirable to maintain communication services for as long as possible before a disaster. Subscribers rely on their wireless phones and wireless data network connections to receive important disaster related information, to coordinate emergency plans, to comfort worried loved ones, to finalize business transactions, and the like. On the other hand, these same subscribers have a strong communication need immediately after a disaster, for many of the same reasons. These post-disaster needs can even be more sever since alternative communications, such as line-based phone and internet services can be unavailable.

Radio Frequency (RF) antennas on base stations represent one critical component of a wireless telecommunication infrastructure which is highly susceptible to weather-related and natural disasters. When left exposed to abnormal weather, these antennas are frequently damaged. This damage is not only costly, but also results in service downtime until repairs are made. In a widespread disaster, such as a hurricane, reserves of spare parts for repairing RF antennas and an availability of skilled repair technicians can both be scarce. Delays repairing RF antennas can be substantial.

The simplest way to prevent these problems is to attempt to remove the RF antennas immediately before the disaster so that the antennas are not exposed to the adverse weather conditions. FR antennas, however, are generally heavy, bulky, and located in inconvenient, elevated locations. For example, many of these locations are near highways and are postioned to maximize coverage of a wireless network. These locations are not designed for easy repair or access. Further, many RF antennas are sensitive components that suffer damage when improperly reconstructed. As a result, it can be difficult if not impossible to rapidly remove RF antennas in anticipation of a disaster. Even when possible, a massive deployment of skilled personnel and specialized equipment can be required. Danger to these skilled people geometrically increases as a disaster approaches.

To add further complications, most weather-based and natural disasters are semi-unpredictable by nature. Up until a day or even an hour before such as disaster, it can be uncertain as to whether a disaster will actually occur and the exact location. When disaster is certain, little time remains. Hence, communication providers are generally forced to either take down RF antennas long before a disaster is certain, or to leave a significant portion of their RF antennas in place and to deal with damaged antennas after a disaster. Both decisions are costly in terms of manpower, equipment, and subscriber satisfaction.

### SUMMARY OF THE INVENTION

The present invention discloses an antenna system including a protective housing and an antenna paired to the housing. The antenna can be mounted onto a pneumatically controlled base platform. When power is present, an air compressor can be activated to pressurize a chamber of the protective housing that causes the base platform to rise or fall. When the chamber is pressurized, the RF antenna can be raised to an operational position, and when depessurized the antenna can be secured in its protective housing, where it is safe from weather conditions.

In the invention, a depressurization value can be automatically opened when power is lost. The open depressurization valve can depressurize the pressure chamber causing the base platform to be lowered. This results in the RF antenna automatically retracting into the protective housing. The depressurization valve can automatically close when power is restored resulting in the air compressor also being automatically activated, which results in the RF antenna being automatically raised to the operating position.

The invention is not limited to pneumatically controlled mechanisms and other mechanisms accomplishing equivalent purposes can be substituted. For example, a hydraulic pump and hydraulic depressurization valve can replace the pneumatic components for an equivalent net effect. The invention is also not limited to activation based upon power on/power off events and any antenna lowering/raising event can be used herein.

The present invention can be implemented in accordance with numerous aspects consistent with the material presented herein. For example, one aspect of the present invention can include a system for protecting a base station antenna that includes an antenna mounted to a platform base. The base can be raised and lowered depending upon an amount of pressure in a pressure chamber. A pressure generator can increase the amount of pressure in the pressure chamber. A depressurization valve can decrease the amount of pressure in the pressure chamber. A protective housing can protect the antenna from environmental conditions. When in the deactivated state, the antenna can be lowered into the protective housing. When in an operational state, at least a portion of the antenna can be raised above the protective housing so that the antenna can send and receive radio frequency signals.

Another aspect of the present invention can include a base station comprising of a protected antenna assembly. The assembly can include a RF antenna and a protective housing for the radio frequency antenna. The RF antenna can be raised from the protective housing and lowered into the protective housing using pneumatics. The RF antenna can be automatically lowered into the protective housing when the bases station loses power.

Still another aspect of the present invention can include a method for protecting an antenna. The method can include a step of mounting an antenna to a platform base. The platform base can be coupled to a pressure chamber. An amount of pressure in the chamber can be changed. The pressure change can result in the platform base moving. One position of the platform base can position the antenna in an operational position for receiving and transmitting wireless signals. A different position of the platform base can position the antenna within a protective housing, which protects the antenna from potentially harmful environmental conditions.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

The method detailed herein can also be a method performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic digram of a system of a communication network including base stations having protected antenna assemblies in accordance with an embodiment of the inventive arrangements disclosed herein.

FIG. 2 is a schematic diagram of a system for an antenna assembly that permits an antenna to be selectively secured in a protective housing in accordance with an embodiment of the inventive arrangements disclosed herein.

FIG. 3 is a flow chart of a method for lowering an antenna into a protective housing in accordance with an embodiment of the inventive arrangements disclosed herein.

FIG. 4 is a flow chart of a method for raising an antenna from a protective housing in accordance with an embodiment of the inventive arrangements disclosed herein.

### DETAILED DESCRIPTION OF THE INVENTION

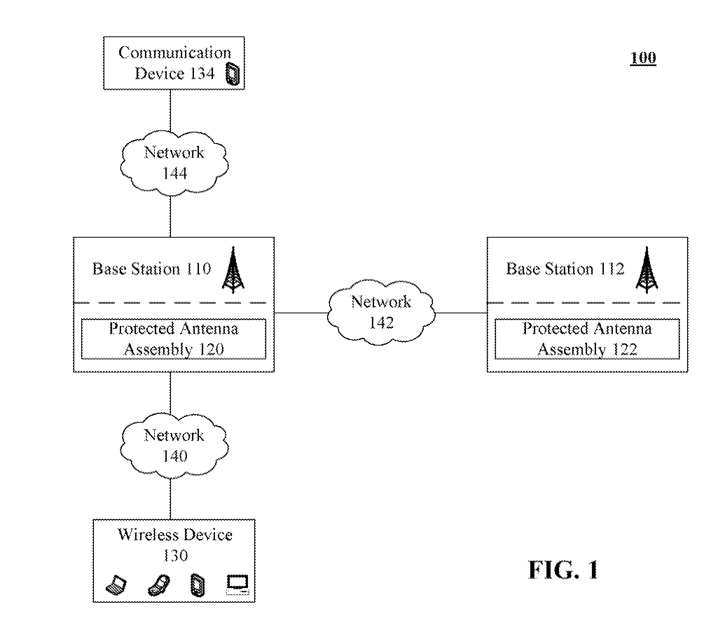

FIG. 1 is a schematic diagram of a system 100 of a communication network including base stations 110-112 having protective antenna assemblies 120-122 in accordance with an embodiment of the inventive arrangements disclosed herein. The protected antenna assemblies 120-122 can include an antenna mounted on an antenna platform which rises and falls based upon an amount of pressure in a pressure chamber. The pressure chamber can be pneumatically or hydraulically controlled. When the platform is completely lowered, the mounted antenna can be contained within a protective housing where it is safe from environmental conditions. When completely raised, the mounted antenna can be in an operational position where it can be used. A power outage can cause pressure in the chamber to be reduced, which can result in the antenna being automatically lowered into the protective housing.

In system 100, each base station 110 can be a transmitting/receiving station that wirelessly communicates with one ore more wireless device 130 via network 140. Base station 110 can be a base station for any type of radio frequently (RF) communications. For example, the base station 110 can be a macrocellular base station for a mobile phone network. The base station 110 can also be a WiMax base station, a WiFi (referring to any of the 802.11 family of communication protocols) base station, or the base station for any other type of RF communications.

Base station 110 can also communicate with base station 112 via network 142 and with communication device 134 via network 144. Base station 110 can use a dish antenna to communicate with base station 112 via a microwave link. Alternatively, base station 110 can be linked to base station 112 via a land-line such as a buried cable. Network 144 can be a land-line network, such as the Public Switched Telephone Network (PSTN) or a data network.

Devices 130 and/or 134 can be any device configured to exchange carrier wave encoded content with other devices. Wireless device 130 can, for example, be a mobile telephone, a computer, a computing tablet, a personal data assistant (PDA), a navigational device, an entertainment console, a media player, a wearable computing device, and the like.

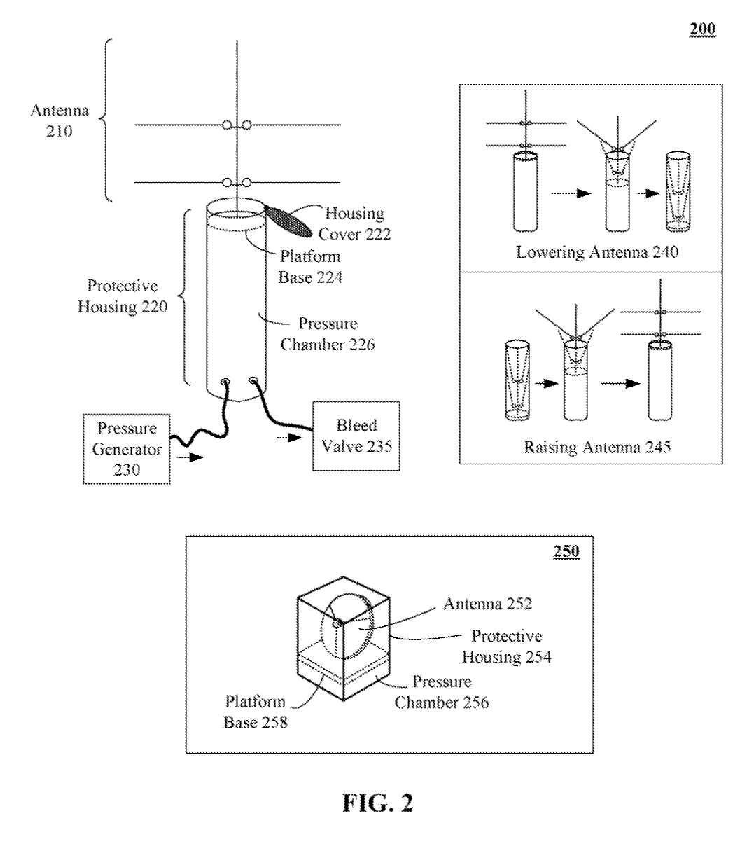

FIG. 2 is a schematic diagram of a system 200 for an antenna assembly that permits an antenna 210 to be selectively secured in a protective housing 220 in accordance with an embodiment of the inventive arrangements disclosed herein. The antenna assembly shown in system 200 can be an assembly of a base station, such as base station 110 or 112.

System 200 can include an antenna 210 which is mounted on a platform base 224. The platform base 224 can be raised and lowered in a protective housing 220 depending upon an amount of pressure in pressure chamber 226. A pressure generator 230 can increase this pressure. A depressurization valve or bleed valve 235 can decrease pressure in chamber 224.

Diagram 240 illustrates how the antenna 210 can be lowered into the protective 220. When fully lowered, an optional housing cover 222 can seal the opening of housing 220 to provide additional environmental protection. Diagram 245 illustrates how the antenna 210 can be raised from the protective housing 220. As shown in diagrams 240 and 245, one or more components of antenna 210 can be folded so they fit more easily into housing 220.

In one embodiment, the pressurizing technology that causes the antenna 210 to raise and lower can be a pneumatic technology. That is, the pressure generator 230 can be an air compressor and the valve 235 can be an air release valve.

In another embodiment, the weight of the antenna 210 and platform base 224 can be great enough that generating sufficient force using a pneumatic mechanism is difficult. In such a case, a hydraulic mechanism can be used. In a hydraulic embodiment, the pressure chamber 228 can include an incompressible liquid, such as oil or water.

The antenna 210 can be any type of RF antenna. For example, antenna 210 can be a panel-shaped sector antenna or a pole shaped omni directional antenna when used as a component of a mobile telephony base station. Antenna 210 can include, but is not limited to, a dipole antenna, a Yagi-Uda antenna, a loop antenna, a parabolic antenna, a phased array antenna, and the like.

As shown by diagrams 240 and 250, the antenna 240 can be configured to collapse or to fold into the protective housing 220. This behavior can be automatic depending upon the level of base 224 changing or can require additional mechanical actions, such as actuators that move/rotate antenna elements to a desired position. These mechanical actions can be powered by a separate power source (not shown), such as a battery, or can be powered by capturing energy generated by air/fluid being pushed out of chamber 226.

In one embodiment, shown by diagram 250, the concept of an automatic telescoping antenna being protected by a protective housing can be applied to any type of antenna, not just to RF antennas. For example, a microwave antenna, a type of antenna often used to communicate between base stations, can be paired to a protective housing 254. Because of the weight consideration and relative costs, pneumatic actuation mechanisms can be preferred for RF antennas, where other types of antennas can require hydraulic actuation mechanisms.

Turning back to diagram 250, diagram 250 shows an antenna 252 mounted to a platform base 258, which is raised and lowered relative to a protective housing 254 as pressure in a pressure chamber 256 changes. Diagram 250 visually illustrates that the shape, size, and mechanical details of the protective housing 254 and inclusive elements will situationally vary depending upon the size, shape, and type of the antenna 252 that is to be protected.

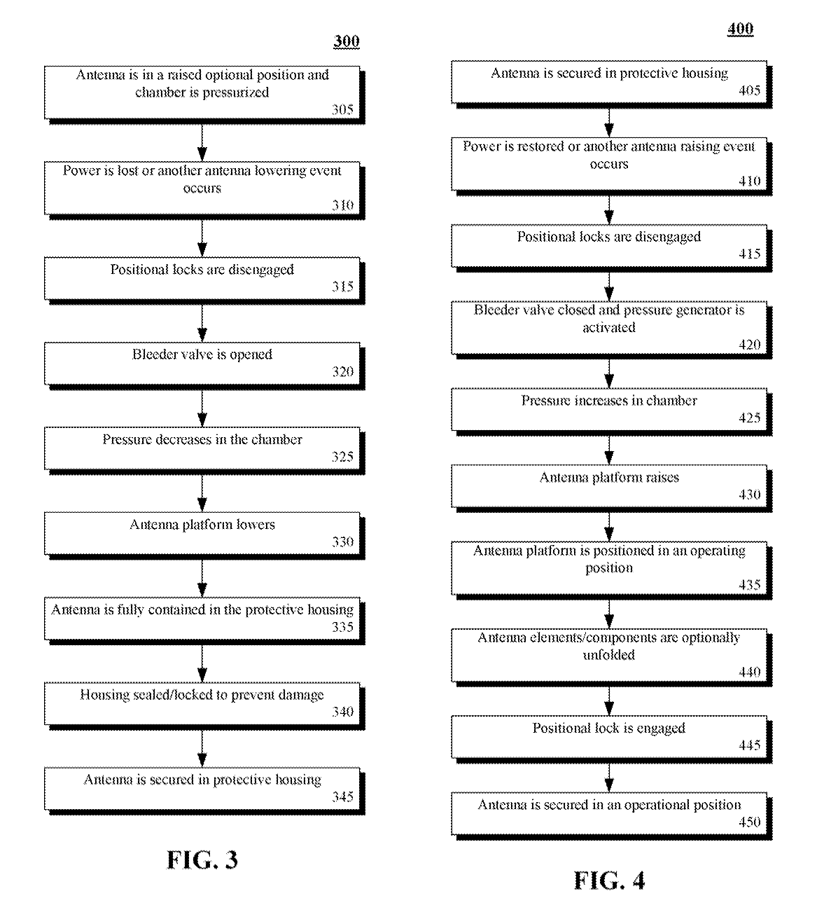

FIG. 3 is a flow chart of a method 305 for lowering an antenna into a protective housing in accordance with an embodiment of the inventive arrangements disclosed herein. The method 300 can be performed in the context of a system 100 or system 200.

The method 300 can begin in step 305, where an antenna starts in a raised operational position. The antenna can be mounted on an antenna platform, which is connected to a pressure chamber. The platform can be raised when the pressure chamber is pressurized and lowered when the pressure chamber is depressurized.

In step 310, an antenna lowering event can occur. For example, power can be lost, which can automatically trigger the lowering of the antenna. Other antenna lowering events can include, but are not limited to, an administrator selecting an antenna lower button, harmful atmospheric conditions being detected that are programmatically linked to lowering the antenna, and the like. The atmospheric condition can be detected by one or more sensors designed for this purpose. For example, when hurricane strength winds or a severe lighting storm are nearby, an antenna lowering event can fire. Different antenna lowering events and conditions can be configured by an authorized system administrator.

In step 315 once the lowering event occurs, any existing positional locks associated with a raised antenna can be disengaged. In step 320, a depressurization valve of the pressure chamber can be opened, which results in the pressure in the chamber decreasing, as shown by step 325. In step 330 as the pressure in the chamber decreases, the antenna platform can lower, which lowers the mounted antenna into a protective housing. In step 335, the antenna can be lowered so that it is fully contained in the protective housing. In optional step 340, the housing can be sealed and/or locked. For example, a cover can be placed over the opening of the protective housing to repel rain, wind, and the like. In step 345, the antenna can be secured in the protective housing where it can safely remain during adverse weather conditions and/or a power outage. It should be noted that a small backup power source, such as a battery, can be optionally used to power locks, the housing cover, and other components involved in lowering the antenna.

FIG. 4 is a flow chart of a method 400 for raising an antenna from a protective housing in accordance with an embodiment of the inventive arrangements disclosed herein. The method 400 can be performed in the context of a system 100 or a system 200.

The method 400 can begin in step 405, where an antenna starts in a protected position where it is secured within a protective housing. In step 410, previously lost power can be restored or another antenna raising event can occur. In step 415, positional locks that may have been previously engaged can be disengaged. In step 420, a depressurization valve can be closed and a pressure generator can be activated. In step 425, pressure can increase in the pressure chamber. In step 430, the increased pressure can cause the antenna platform to rise. In step 435, the antenna platform can be fully raised to an operational position.

In optional step 440, antenna elements/components can be optionally unfolded as necessary. It should be appreciated that having otherwise protruding antenna elements folded or secured until the antenna platform is fully raised can minimize damage to the antenna during raising and lowering operations.

In step 445, a positional lock can be optionally engaged to secure the antenna platform and/or unfolded antenna components in an operational position. In step 450, the antenna can be fully secured in an operational position, where it can be utilized.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A system for protecting an antenna comprising:
an antenna mounted to a platform base, which raises and lowers the antenna based upon an amount of pressure in a pressure chamber;
a pressure generator that increases the amount of pressure in the pressure chamber;
a depressurization valve that decreases the amount of pressure in the pressure chamber; and
a protective housing configured to protect the antenna from environmental conditions, wherein when in a deactivated state, the antenna is lowered into the protective housing, and when in an operational state, at least a portion of the antenna is raised above the protective housing.

2. The system of claim 1, further comprising:
housing cover that is closed when in a deactivated state to encapsulate the antenna within the protective housing.

3. The system of claim 1, wherein the antenna is a radio frequency antenna of a base station, wherein the base station is at least one of a macrocellular base station of a mobile phone network, a base station for a WiFi network, and a base station for a WiMax network.

4. The system of claim 1, wherein the platform base moves based on pneumatic principles, wherein the pressure chamber is pressurized using air, wherein the pressure generator is an air compressor.

5. The system of claim 1, wherein the platform base moves based on hydraulic principles, wherein the pressure chamber is pressurized using a liquid, wherein the pressure generator is a hydraulic pump.

6. The system of claim 1, wherein the antenna is automatically lowered into the protective housing when power is lost.

7. The system of claim 1, wherein the antenna is automatically raised from a protected position within the protective housing into an operational position once lost power is restored.

8. A base station comprising:
a protected antenna assembly comprising a radio frequency antenna and a protective housing for the radio frequency antenna, wherein the radio frequency antenna is raised from the protective housing and lowered into the protective housing using pneumatics, wherein the antenna is automatically lowered into the protective housing when the base station loses power.

9. The base station of claim 8, wherein the base station is at least one of a macrocellular base station of a mobile phone network, a base station for a WiFi network, and a base station for a WiMax network.

10. A method for protecting an antenna comprising:
mounting an antenna to a platform base, wherein said platform base is coupled to a pressure chamber; and
changing the pressure in the pressure chamber, which results in said platform base moving, wherein one position of the platform base positions the antenna in an operational position for receiving and transmitting wireless signals, wherein a different position of the platform base positions the antenna within a protective housing, which protects the antenna from potentially harmful environmental conditions.

11. The method of claim 10, wherein the antenna is a radio frequency antenna of a base station.

12. The method of claim 10, further comprising:
activating a pressure generator to increase pressure in the pressure chamber.

13. The method of claim 11, further comprising:
opening a depressurization valve to decrease pressure in the pressure chamber.

14. The method of claim 11, wherein the platform base moves based on pneumatic principles, wherein the pressure chamber is pressurized using air, wherein the pressure generator is an air compressor.

15. The method of claim 11, wherein the platform base moves based on hydraulic principles, wherein the pressure chamber is pressurized using a liquid, wherein the pressure generator is a hydraulic pump.

16. The method of claim 11, wherein gravity causes the antenna to automatically recede into the protective housing whenever the pressure generator remains dormant for a period of time.

17. The method of claim 10, further comprising:
lowering the platform base so that the antenna is contained within the protective housing; and
closing a housing cover to encapsulate the antenna within the protective housing.

18. The method of claim 10, wherein the antenna is automatically lowered into the protective housing when power is lost.

19. The method of claim 10, wherein the antenna is automatically raised from a protected position within the protective housing into an operational position once lost power is restored.

20. The method of claim 10, further comprising:
folding components of the antenna so that the antenna is able to fit within the protective housing when lowering the platform from an operational position to a position that places the antenna within the protective housing.
